(19) United States
(12) Patent Application Publication
(10) Pub. No.: US 2008/0281828 A1
(43) Pub. Date: Nov. 13, 2008

(54) Variable Data Replacement Technique For An Electronic Communication System

(76) Inventors: Daniel Swartz, Glen Ellyn, IL (US); Michael Ferguson, Bolingbrook, IL (US); Alvydas Jaliniauskas, Naperville, IL (US)

Correspondence Address: MCANDREWS HELD & MALLOY, LTD, 500 WEST MADISON STREET, SUITE 3400, CHICAGO, IL, 60661, US

(21) Appl. No.: 11/747,811

(22) Filed: May 11, 2007

(51) Int. Cl. G06F 17/30

(52) U.S. Cl. 707/10; 707/E17.117

(57) ABSTRACT

A method and system for composing electronic communications retrieves and provides, in real-time or near-real time, personalized content data from electronically accessible content sources using replaceable tokens. A replaceable token points to a defined location of an electronically accessible content source. The token is identified, and the desired content data is extracted from the defined location. The token is replaced with the extracted content data, and the personalized or customized content data is inserted into one or more electronic communications.

### FIELD OF THE INVENTION

The present invention relates to the electronic communication field, and more specifically to the customization of electronic communications, especially email messages.

### BACKGROUND OF THE INVENTION

Within electronic communication systems, replaceable “tokens” act as placeholders for variable or customized data to be inserted or merged into electronic communication content. Such data could include personalized data or time-sensitive data to be included in communications to prospective recipients.

Persons familiar with the technology involved here will appreciate that a “token” is a replaceable data entity and can also be referred to as, among other terms, a variable, custom block, custom field, merge tag, personalization field, or personalized content.

Conventional techniques for creating customized content for a large number of recipients require an inordinate amount of setup time and data preparation. These conventional techniques also require data to be extracted from various data sources and synchronized prior to the merging process. Also, in these conventional techniques, content is not compiled in real time, and in some instances rules are set for separate items of data. In a mass communication environment, this could require thousands or millions of rules to be made and applied. Time-sensitive and customized content would be constantly changing, and data would need to be moved to readily accessible sources at the moment each message is compiled.

Some of the problems associated with the personalization of electronic communications in conventional electronic communication systems include rapidly changing data that requires actual data synchronization from various remote and local data sources. Additionally, ensuring that the data in conventional systems is current (that is, “fresh”) involves significant computing power and maintenance. Moreover, depending upon the application, many data fields in conventional systems would be required to administer this process.

Conventional systems have thus failed to adequately solve the problems associated with the customization of multiple mass electronic communications in a timely manner because they require excessive effort to set up rules, and/or frequent data synchronization. Such conventional systems represent a somewhat static approach, requiring parameters and content to be in place before the electronic communication is compiled.

The present, newly-developed technique handles token replacement on an individualized basis, enabling automated retrieval of real-time data or near-real-time data from various data sources and locations. “Real-time data” means information that is extracted from a source, and is then incorporated into an electronic communication substantially immediately. “Near-real-time data” means information that is extracted from a source and is not immediately incorporated into an electronic communication, but is instead incorporated after the passage of time, but when the information is still at an acceptable level of freshness.

The present technique includes ways of retrieving data to be incorporated from various local and remote data sources in real-time or near-real time. Of course, in creating an electronic communication, the present technique can also be used in addition to one or more of the conventional content customization techniques discussed above.

The present technique is similar in some ways to techniques utilized in the Internet context, including the use of image tags, portal pages, RSS feeds, and Asynchronous JavaScript and XML (AJAX). However, techniques used in the Internet context are directed to providing desired content to one user at a time as it is individually requested. In contrast, the present technique is capable of providing real-time or near-real time content data that is personalized for each of a multitude of communication recipients. Thus, as compared to existing Internet technologies, the present technique allows for creation of mass electronic communications for many recipients. Additionally, the present technique is directed to applications in the electronic communications context, including but not limited to electronic email, which includes applications different from those associated with existing Internet technologies.

### SUMMARY OF THE INVENTION

One or more shortcomings of prior, conventional electronic communication techniques are overcome with by the present system and method for composing electronic communications. An embodiment of the present technique first identifies at least one replaceable token pointing to a location containing content data to be inserted into one or more electronic communications. Next, the content data is extracted from the location defined by the at least one replaceable token. Finally, the token is replaced with the extracted content data, and personalized or customized content is inserted into the electronic communication or system as the communication is compiled.

Moreover, the defined location can be internal to the system, such as, for example, a locally-maintained database or server. The defined location can also be external to the system, in which case the external location can be referenced via a Uniform Resource Identifier (URI). The URI can identify resources located on web servers, database servers, or electronic and optical data storage devices.

In a preferred embodiment, the selected content data is extracted from the location referenced by the one or more replaceable tokens, and each token is replaced with the content data it references while the at least one electronic communication is being compiled.

In another preferred embodiment, the present technique is capable of searching for one or more replaceable tokens containing content data that will be inserted into one or more electronic communications.

### BRIEF DESCRIPTION OF THE DRAWING(S)

These and further objects, features, and advantages of the present invention will be more apparent from the appended drawings.

FIG. 1 is a flow diagram illustrating the retrieval and provision, in real-time or near-real time, of customized content data from an electronically accessible source using a replaceable token.

FIG. 2 illustrates the use of a replaceable token to retrieve and merge personalized content data into an electronic communication.

FIG. 3 illustrates an example application of the present content customization technique as applied to a personalized newsletter containing job openings.

### DETAILED DESCRIPTION OF PREFERRED EMBODIMENT(S) OF THE INVENTION

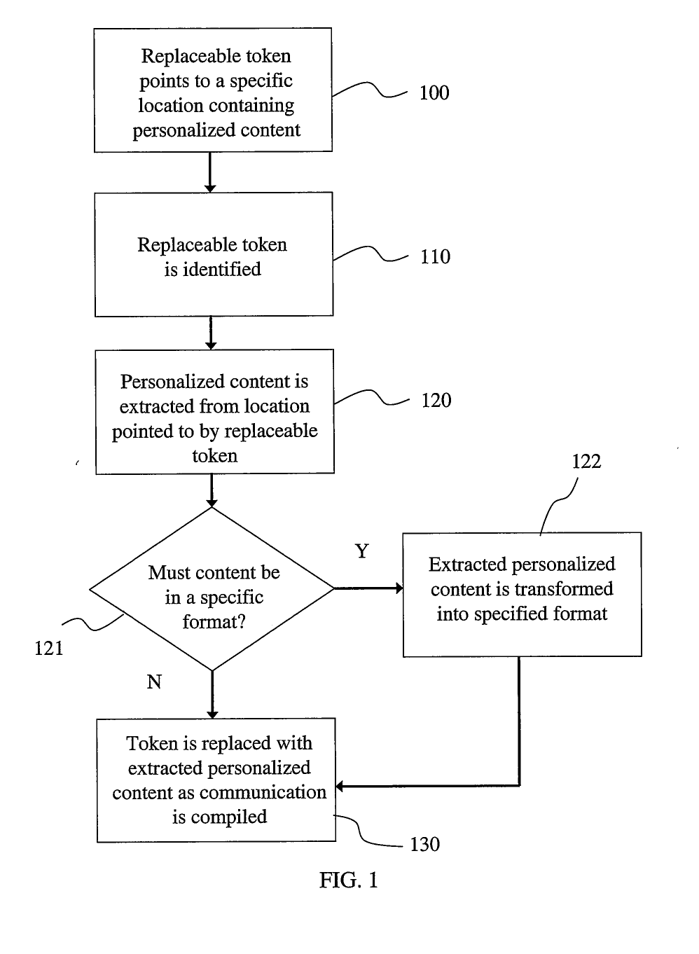

Turning to FIG. 1, an embodiment of the present technique includes steps 100, 110, 120, and 130, as well as decision point 121 and conditional step 122. At step 100, the system provides a replaceable token or other variable pointing to a location that contains personalized content to be inserted into one or more electronic communications. The token field is defined so as to be capable of extracting content from any accessible electronic data source.

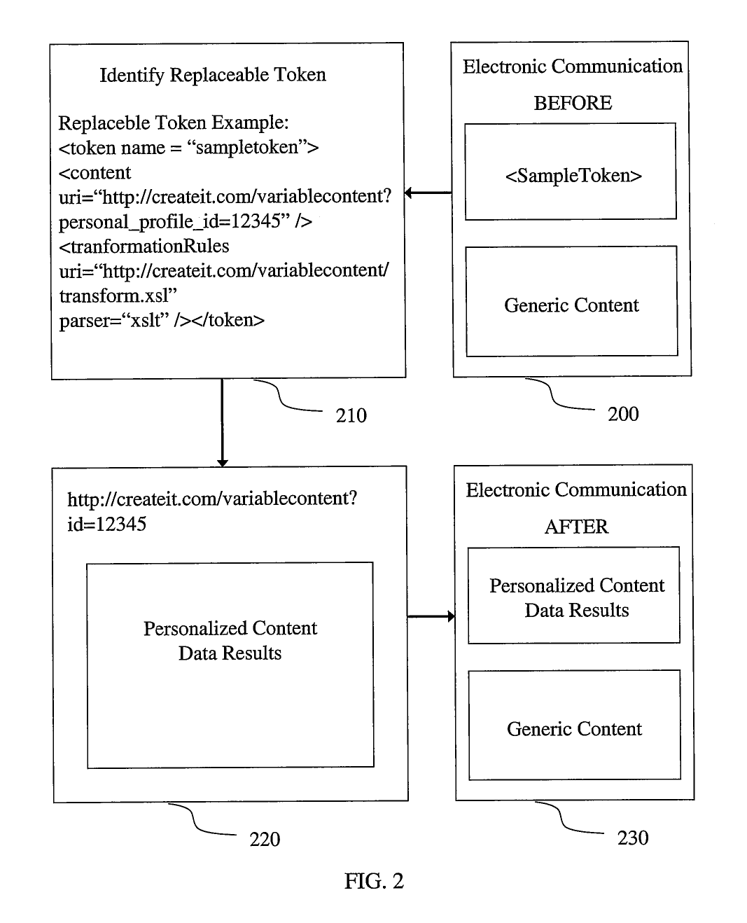

At step 110, the replaceable token is identified. As also shown in FIG. 2, the following is an example of a replaceable token:

<token>

<content uri=“http://createit.com/variablecontent?id=12345”/>

<transformationRules uri=“http://createit.com/variablecontent/transform.xsl” parse=“xslt”/>

Similarly, the following is another example of a replaceable token:

{“content”:

{“uri”: “http://createit.com/variablecontent?id=12345”},

“transformationRules”: {“uri”: “http://createit.com/variablecontent/transform.xsl”,

“parse”: “xslt”}}

The first example replaceable token is represented in XML, a widely-used, human-readable markup language. The second example replaceable token is represented in JavaScript Object Notation (JSON).

The XML replaceable token can also be configured with a different type of invocation that includes data transformation capabilities, as in the following example:

<token>

<content uri=“http://createit.com/variablecontent?id=12345”/>

<transformationRules parse=“regularExpression” pattern=“Job Number [0-9]+”/>

</token>

This alternative type of invocation can also be utilized in a JSON replaceable token, as in the following example:

{“content”:

{“uri”: “http://createit.com/variablecontent?id12345”},

“transformationRules”: {“parse”: “regularExpression”,

“pattern”: “Job Number [0-9]+”}}

The replaceable token can also be configured without any data transformation capabilities, such that the replaceable token is replaced with the literal value of the data pointed to by the replaceable token. A replaceable token represented in XML that illustrates this functionality is shown in the following example:

<token>

<content uri=“http://createit.com/variablecontent?id=12345”/>

</token>

A replaceable token represented in JSON that does not have data transformation capabilities is shown in the following example:

{“content”:

{“uri”: “http://createit.com/variablecontent?id=12345”},

“transformationRules”: {“uri”: “http://createit.com/variablecontent/transform.xsl”,

“parse”: “xslt”}}

Persons familiar with the technology involved here will appreciate that a replaceable token can be expressed in a variety of different computing languages in numerous functionally equivalent ways. Therefore, the present technique is not limited to the syntax or language utilized in the above XML and JSON examples.

At step 120, the system extracts the personalized content that is to be incorporated into one or more electronic communications.

After the data is extracted at step 120, the system or user can decide at decision point 121 to perform additional data transformation to put the extracted content into a specified format for inclusion into the downstream electronic communication. If such a transformation is desired, the extracted personalized content is transformed into the specified format at conditional step 122.

Next, at step 130, the system inserts the personalized content into an electronic communication or system as the content is being compiled.

Turning to FIG. 2, an embodiment of the present technique includes a four-step method of retrieving and merging personalized content data into an electronic communication using one or more replaceable tokens or other variables. Step 200 illustrates an example electronic communication prior to the incorporation of personalized content. As shown in FIG. 2, this example communication contains generic content and a replaceable token.

Step 210 illustrates the identification of the replaceable token. As shown in FIG. 2, the replaceable token points to a specific location (in this example, the website http://createit.com/variablecontent?personal profile_id=12345) that contains personalized content to be included in the electronic communication.

Once the replaceable token has been identified, the specific (personalized) content data is extracted from the location specified by the replaceable token, as shown in step 220 of FIG. 2.

Step 230 illustrates the merging of the extracted personalized content into the electronic communication as the content of that communication is being compiled. As in the example, the communication can include personalized content in addition to generic content that is unaffected by the extraction of the personalized content.

In an embodiment of the present technique, the replaceable token is defined as a resource pointer to a specific location, not limited to local systems or protocols, to retrieve the personalized content data to be compiled and/or merged when composing electronic communications. This enables the final content to be specifically defined for particular recipients and driven by virtually any system defined by the user. In defining a replaceable token, a location for retrieving personalized data could be an external website, an internal database, or other system that can be accessed through URIs or over a variety of other protocols.

The present variable data replacement technique enables an electronic communication system to create specific and personalized electronic communications, including email messages containing personalized content in addition to generic content. The present technique significantly decreases communication setup time, which can include data manipulation and synchronization, and enables personalized content data to be compiled in real-time or near-real time. The present technique also enables further decisions to be made regarding the format of the content to be returned by the system.

An additional advantage of the present technique over conventional systems is the ease with which content can be configured in creating personalized communications. In this regard, personalized content data to be retrieved can reside in virtually any electronically accessible location and in a variety of formats. Additionally, a local or remote system containing data to be incorporated into an electronic communication can pre-process, aggregate, or otherwise manipulate the data prior to the extraction and incorporation of the data.

Another advantage of the present technique is that rules need not be set up upon compilation of personalized content data in composing an electronic communication. A system employing the present technique can create personalized content for an electronic communication in virtually any manner desired, as long as the content data is recognizable by the token replacement system.

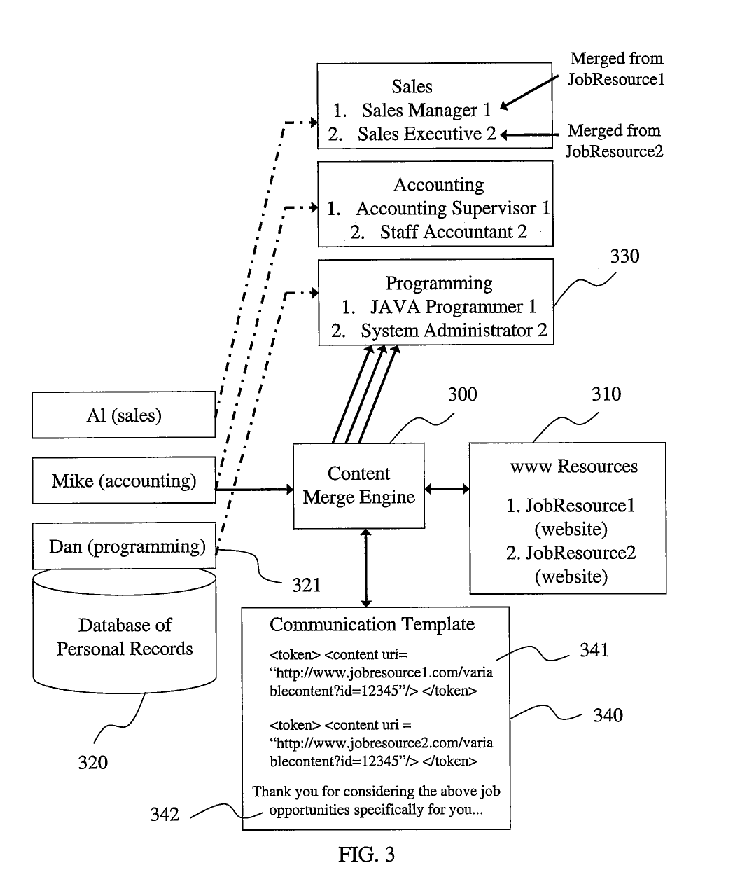

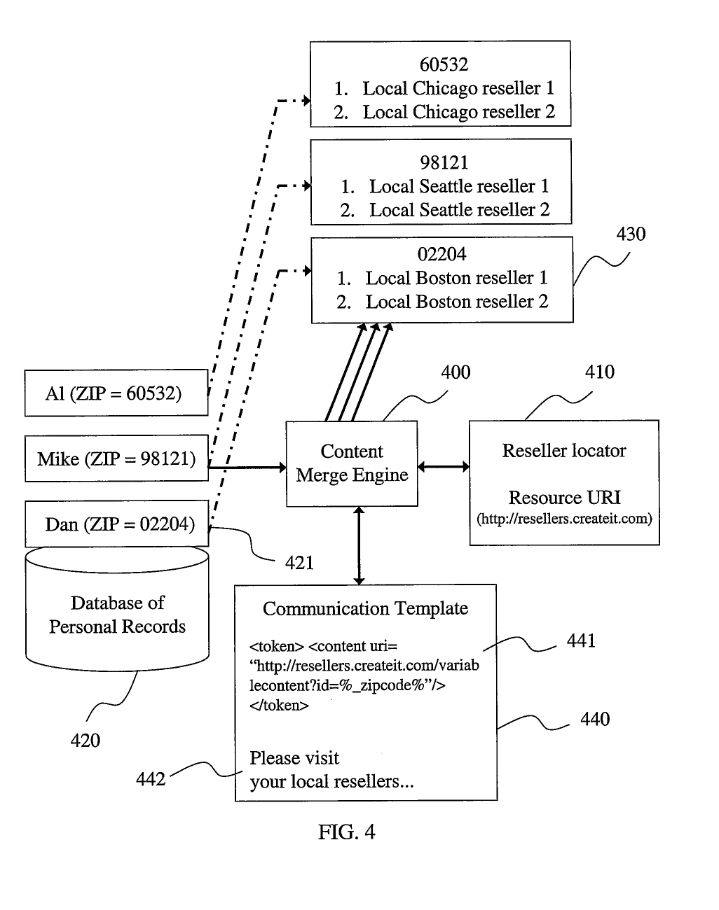

Turning to FIG. 3, an example of the present technique's application to a personalized newsletter containing job openings is provided. Communication template 340 contains a replaceable token 341. Content merge engine 300 identifies replaceable token 341 and extracts job openings from www resources 310 that correspond to each personal record 321 contained in personal records database 320. For example, in compiling an electronic communication intended for Al, content merge engine 300 extracts job openings in the sales field from www resources 3 10 such as the Job Resource 1 website and the Job Resource 2 website. These sales job openings constitute information customized especially for Al based on Al's personal record. Similarly, in compiling an electronic communication intended for Mike, content merge engine 300 extracts job openings in the accounting field from www resources 310 based on Mike's personal record. Finally, in compiling an electronic communication intended for Dan, content merge engine 300 extracts job openings in the programming field from www resources 310 based on Dan's personal record.

Once content merge engine 300 has extracted customized information from www resources 310, replaceable token 341 is replaced with the extracted information. As a result, communication template 340 becomes a personalized newsletter that contains recipient-specific job openings 330. For examples, Al's personal newsletter would contain a listing of sales job openings, as well as generic content 342. Similarly, Mike's personal newsletter would contain a listing of accounting job openings, as well as generic content 342. Finally, Dan's personal newsletter would contain a listing of programming job openings, as well as generic content 342.

Turning to FIG. 4, an example of the present technique's application to a personalized newsletter containing local reseller information is provided. Communication template 440 contains a replaceable token 441. Content merge engine 400 identifies replaceable token 441 and extracts local reseller information from reseller locator 410 that contains reseller location information corresponding to each personal record 421 contained in personal records database 420. For example, in compiling an electronic communication intended for Al, content merge engine 400 extracts information regarding resellers located in the Chicago area from a source identified by a resource URI associated with reseller locator 410. These Chicago reseller locations constitute information customized especially for Al based on Al's personal record. Similarly, in compiling an electronic communication intended for Mike, content merge engine 400 extracts information regarding resellers located in the Seattle area from reseller locator 410 based on Mike's personal record. Finally, in compiling an electronic communication intended for Dan, content merge engine 400 extracts information regarding resellers located in the Boston area from reseller locator 410 based on Dan's personal record.

Once content merge engine 400 has extracted customized information from reseller locator 410, replaceable token 441 is replaced with the extracted information. As a result, communication template 440 becomes a personalized newsletter that contains recipient-specific reseller locations 430. For example, Al's personal newsletter would contain a listing of resellers located in Chicago, as well as generic content 442. Similarly, Mike's personal newsletter would contain a listing of Seattle resellers, as well as generic content 442. Finally, Dan's personal newsletter would contain a listing of Boston resellers, as well as generic content 442.

Of course, FIGS. 3 and 4 illustrate only two example application of the present technique. The present technique can be applied in a variety of contexts within the field of electronic communication.

While particular elements, embodiments and applications of the present invention have been shown and described, it will be understood, of course, that the invention is not limited thereto since modifications can be made by those skilled in the art without departing from the scope of the present disclosure, particularly in light of the foregoing teachings.

What is claimed is:

1. A method for composing electronic communications, said method comprising the steps of:
(a) providing at least one replaceable token, said at least one replaceable token pointing to at least one defined location containing retrievable content data to be inserted into at least one electronic communication, wherein said at least one defined location exists in or outside a local system;
(b) identifying said at least one replaceable token;
(c) extracting said content data from said defined location; and
(d) replacing said replaceable token with said content data.

2. The method of claim 1, wherein said identifying comprises searching for said at least one replaceable token.

3. The method of claim 1, wherein said at least one electronic communication is one electronic communication and said at least one replaceable token is one replaceable token pointing to a defined location containing retrievable content data to be inserted into said one electronic communication.

4. The method of claim 1, wherein said at least one electronic communication is one electronic communication and said at least one replaceable token is a plurality of replaceable tokens, each pointing to a defined location containing retrievable content data to be inserted into said one electronic communication.

5. The method of claim 1, wherein said at least one electronic communication is a plurality of electronic communications and said at least one replaceable token is one replaceable token pointing to a defined location containing retrievable content data to be inserted into said plurality of electronic communications.

6. The method of claim 1, wherein said at least one electronic communication is a plurality of electronic communications and said at least one replaceable token is a plurality of replaceable tokens, each pointing to a defined location containing retrievable content data to be inserted into said plurality of electronic communications.

7. The method of claim 1, wherein said defined location is internal to said system.

8. The method of claim 7, wherein said defined internal location is at least one of a locally-maintained database and a server.

9. The method of claim 1, wherein said defined location is external to said system.

10. The method of claim 9, wherein said external location is capable of being referenced via a Uniform Resource Identifier (URI).

11. The method of claim 10, wherein said URI identifies a resource located on at least one of a web server, a database server, and a data storage device.

12. The method of claim 1, wherein said system is capable of transforming said content data into at least one specified format for use in composing said at least one electronic communication.

13. The method of claim 1, wherein said content data is extracted from said defined location and inserted into said at least one replaceable token while said at least one electronic communication is being compiled.

14. An electronic communication system comprising:
(a) at least one replaceable token, said at least one replaceable token pointing to at least one defined location containing retrievable content data to be inserted into at least one electronic communication;
(b) a local electronic system capable of:
(1) identifying said at least one replaceable token;
(2) extracting said content data from said defined location; and
(3) replacing said replaceable token with said content data.

15. The system of claim 14, wherein said system is capable of searching for said at least one replaceable token.

16. The system of claim 14, wherein said at least one electronic communication is one electronic communication and said at least one replaceable token is one replaceable token pointing to a defined location containing retrievable content data to be inserted into said one electronic communication.

17. The system of claim 14, wherein said at least one electronic communication is one electronic communication and said at least one replaceable token is a plurality of replaceable tokens, each pointing to a defined location containing retrievable content data to be inserted into said one electronic communication.

18. The system of claim 14, wherein said at least one electronic communication is a plurality of electronic communications and said at least one replaceable token is one replaceable token pointing to a defined location containing retrievable content data to be inserted into said plurality of electronic communications.

19. The system of claim 14, wherein said at least one electronic communication is a plurality of electronic communications and said at least one replaceable token is a plurality of replaceable tokens, each pointing to a defined location containing retrievable content data to be inserted into said plurality of electronic communications.

20. The system of claim 14, wherein said defined location is internal to said system.

21. The system of claim 14, wherein said defined internal location is at least one of a locally-maintained database and a server.

22. The system of claim 14, wherein said defined location is external to said system.

23. The system of claim 22, wherein said external location is capable of being referenced via a Uniform Resource Identifier (URI).

24. The system of claim 23, wherein said URI identifies a resource located on at least one of a web server, a database server, an electronic data storage device, and optical data storage device.

25. The system of claim 14, wherein said system is capable of transforming said content data into at least one specified format for use in composing said at least one electronic communication.

26. The system of claim 14, wherein said content data is extracted from said defined location and inserted into said at least one replaceable token while said at least one electronic communication is being compiled.
